(19) United States
(12) Patent Application Publication
(10) Pub. No.: US 2015/0154404 A1
(43) Pub. Date: Jun. 4, 2015

(54) METHOD FOR PROVIDING PRIVACY PROTECTION IN NETWORKED LIGHTING CONTROL SYSTEMS

(71) Applicant: KONINKLIJKE PHILIPS N.V., EINDHOVEN (NL)

(72) Inventors: Maulin Dahyabhai Patel, Tuckahoe, NY (US); Murali Mani, Chappaqua, NY (US)

(21) Appl. No.: 14/404,977

(22) PCT Filed: Jun. 4, 2013
(86) PCT No.: PCT/IB2013/054586

§ 371 Date: Dec. 2, 2014

Related U.S. Application Data
(60) Provisional application No. 61/655,029, filed on Jun. 4, 2012.

(51) Int. Cl. G06F 21/60; G06F 3/0484; G06F 3/0482

(52) U.S. Cl. CPC G06F 21/60; G06F 3/0482; G06F 3/04842

(57) ABSTRACT

A method and corresponding system is disclosed for use in a Networked Lighting Control System whereby an individual can determine various privacy settings for data collected that relates to an area in which he/she is being monitored. These various settings include selecting by the individual what specific types of data can be/cannot be collected; whether he/she can be linked to the collected data; and limiting the purpose for which the data can be used.

This application relates to the field of light management systems and more particularly to a method and a system to protect the privacy of lighting control system users and allow them to customize their privacy settings, while minimally impacting the ability to perform Total Light Management using a Networked Lighting Control System (NLCS). This is of interest to building occupants, building administrators, city light operators, parking lot light operators, and in general, to providers of Total Light Management Services (TLMS) in both indoor and outdoor environments.

An NLCS system is an essential component of total light management solutions and services that generate energy savings to end users and potential sources of recurring revenue to operators. NLCSs acquire and process sensor readings that track the location data of users, their preferences and system parameters in a database. Elements of this data have privacy implications. For example, occupancy sensor data from a private office can be used to deduce how much time a given office worker spends in his/her office. This has employment law and anti-discrimination implications. Law-enforcement agencies can subpoena occupancy data. Occupancy data could be used against an organization (e.g. “Federal agency XYZ's employees spend less than 4 hours at their desks, wasting taxpayers' money”). Storing light settings for a vision impaired individual in an identifiable way could violate user's privacy rights.

Another example involving privacy issues relates to the field of light therapy. Light therapy is a potential treatment for various disorders such as depression and Post Traumatic Stress Disorder. One could envisage a NLCS for a healthcare facility where lights are set according to the light therapist's prescription. Thus, the light settings could be linked to patient's health records. In these scenarios, the Service Provider of NLCS could be held responsible if data is misused.

Yet another example relates to an outdoor setting in which street-lamp mounted motion detectors in proximity to an individual's home, workplace, or other area being monitored can provide location information relative to the individual. By way of example, it could be deduced statistically when a person leaves or arrives at his home by using correlated data obtained from adjacent street lamps on his street. As used herein, the term “home” is meant to include any type of structure in which a user may reside: such as, but not limited to, an apartment, townhouse, condominium, or single family dwelling. If that data is further correlated with time of day, it could be used to pinpoint with relatively high accuracy, repeating behavior, such as when they leave for work or return home at night. Further, when street lamp time-stamps are correlated with other time-stamped data, such as cell-phone time and geolocation data, one could deduce exactly when a person passed a streetlamp in his/her car if he was talking or texting while driving. While gathering of such data may have a legitimate purpose, obtaining consent of the person being monitored may be required to comply with privacy laws in many jurisdictions.

Considerations for the privacy of end-users (and system administrators) must be built into NLCSs in order to make them compliant with laws and regulations and to comply with various company privacy code and rules that respect the privacy of customers and business partners. Privacy compliance will promote the adoption of TLMS in the market.

Energy efficiency and the comfort of occupants are the main drivers for total light management. Integrated control of artificial lights and motorized blinds in a Networked Lighting Control System (NLCS) is important for the optimal use of natural light and artificial light in achieving these goals.

A Hybrid Integrated Lighting and Daylight Control (ILDC) system comprising of Philips sensors, lights, dimming ballasts, networking infrastructure, user interfaces and Somfy motorized blinds has been developed by Philips Research North America. In such a conventional integrated lighting and window covering system there typically exist wireless connectivity among sensors and actuators within a zone and wired connectivity across zones (thus “hybrid”) to enable building-wide deployment. It should be noted that such an ILDC system is just one example of a TLMS and an NLCS in particular.

Each user's workstation is associated with corresponding sensors, thermostat, window blinds and fixtures to enable personalized integrated control. Typically, these controls may be operated in both a manual and an automatic mode. In an automatic mode, the system combines user preferences with sensor readings (occupancy and light level) to harvest natural light through integrated control of motorized blinds and electric light. Artificial lights are regulated using occupancy and light sensors. If the space is occupied, blinds are open to allow in daylight to an extent that does not cause discomfort (glare); moreover, lights are dimmed to the level such that the overall illumination meets the user's requirement.

Data related to these various parameters can be collected at a central location. Accordingly, in light of the privacy concerns discussed above, a need exists to provide each individual user with options as to how data related to him/her can be collected and utilized.

The current invention addresses those privacy concerns of the lighting system user. In one aspect of the invention, the content and method of aggregating and storing data related to an individual is changeable by means of options set by the individual involved. Current (or operational) sensor data can and will be used by the NLCS for Total Light Management purposes. Thereby the operational efficiency of the system is unaffected by these privacy choices. What is affected is the way in which stored data could be processed at a later time for problem resolution or improvements in the system performance or quality of service.

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the representative embodiments. Such methods and apparatus are clearly within the scope of the claimed invention. For example, aspects of the methods and apparatus disclosed herein are described in conjunction with and particularly suited for utilization in a lighting control panel. However, one or more aspects of the methods and apparatus described herein may be implemented in other configurations such as, for example, other control products such as personal computers, tablets, push button controllers, smart phones, voice or gesture recognition controllers, window treatment controllers, thermostats and/or ventilation systems that may be installed in a lighting control system.

The above and other exemplary features, aspects, and advantages of the present invention will be more apparent from the following detailed description taken in conjunction with the accompanying drawings, in which:

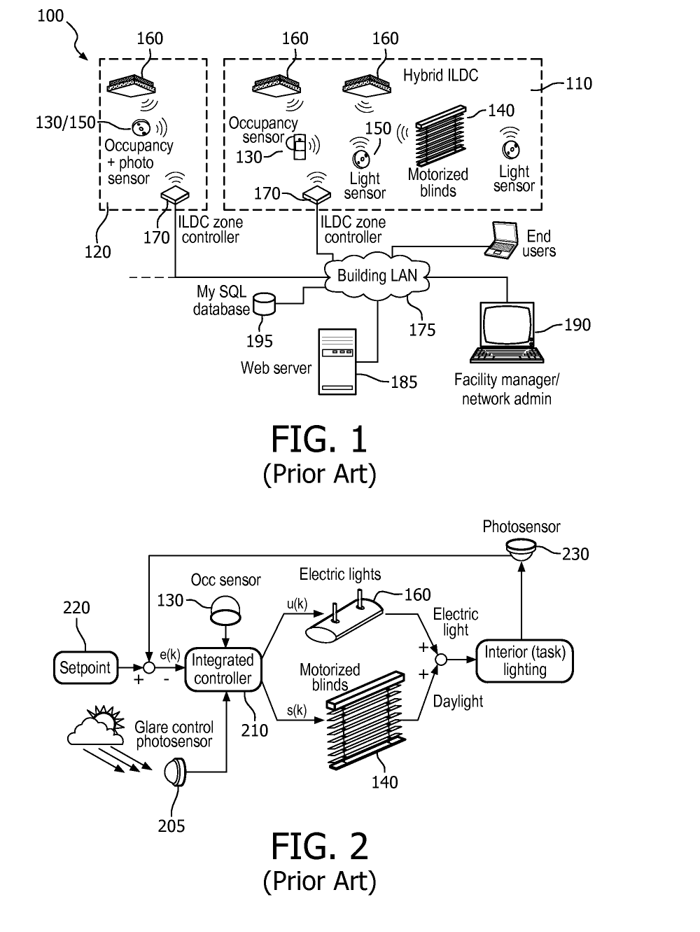

FIG. 1 illustrates a conventional integrated lighting and window covering system.

FIG. 2 illustrates a schematic of conventional integrated lighting and window covering system.

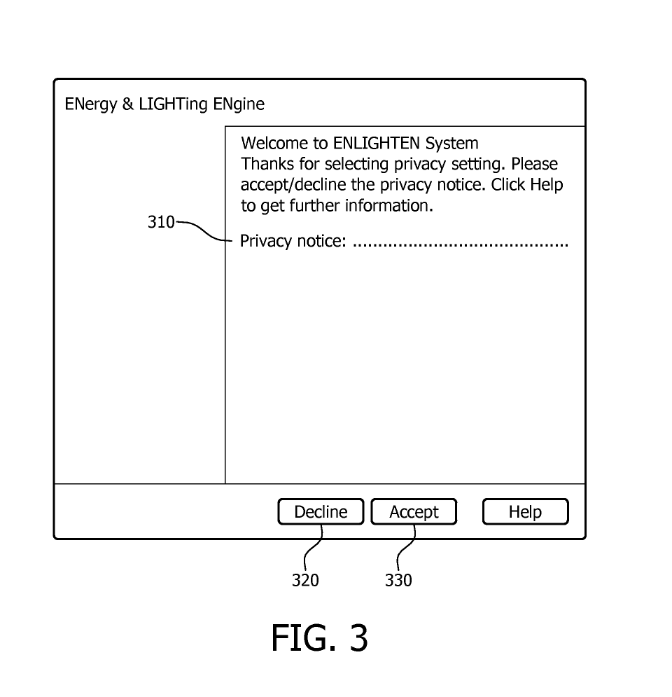

FIG. 3 illustrates a sample user interface for privacy notice selection.

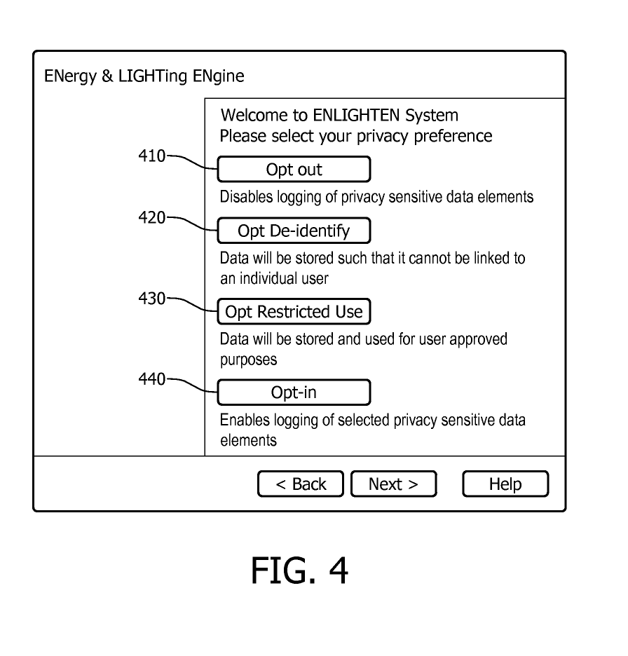

FIG. 4 illustrates a sample user interface for selecting privacy preferences.

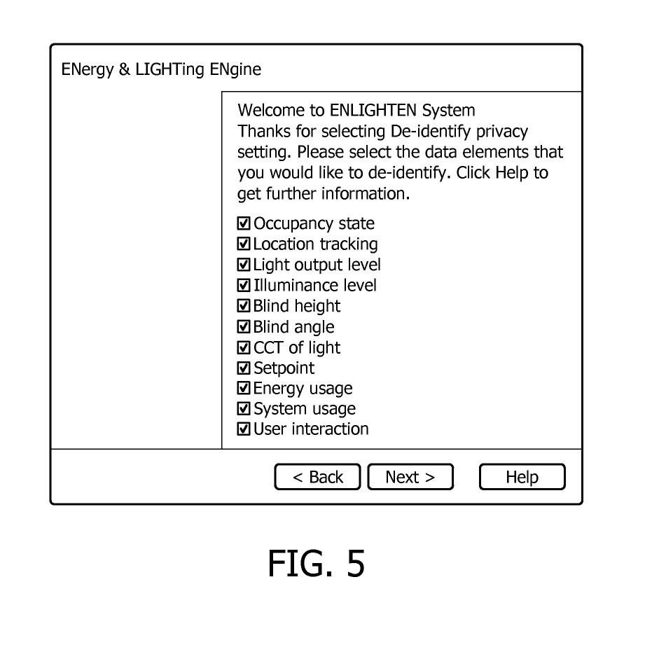

FIG. 5 illustrates a sample user interface for selecting de-identified data elements.

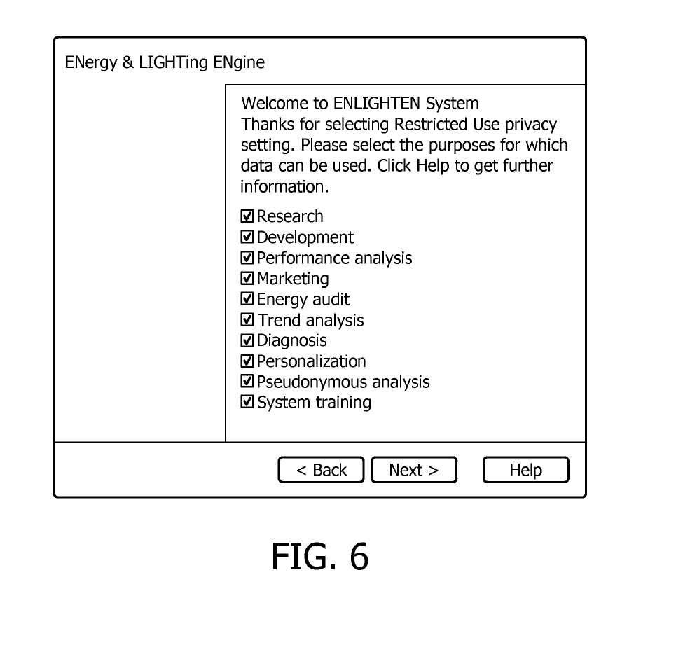

FIG. 6 illustrates a sample user interface for selecting the purpose for which data can be used.

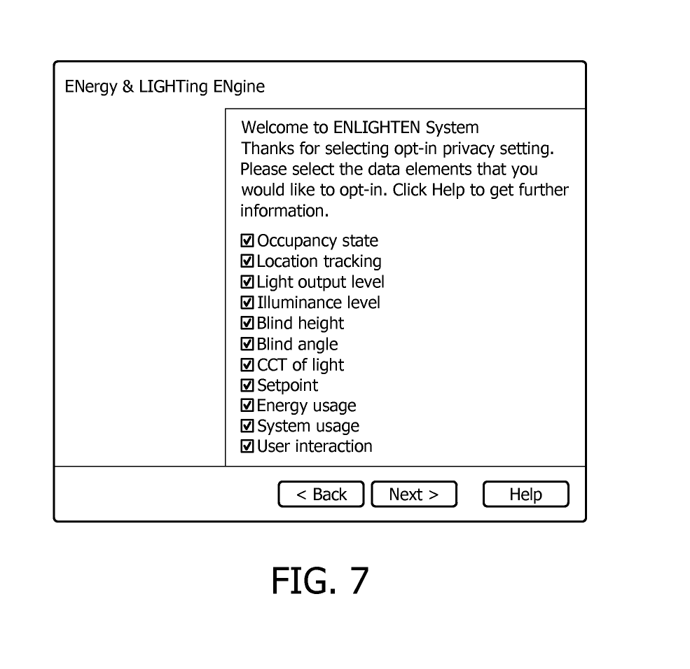

FIG. 7 illustrates a sample user interface for selecting the opt-in data elements.

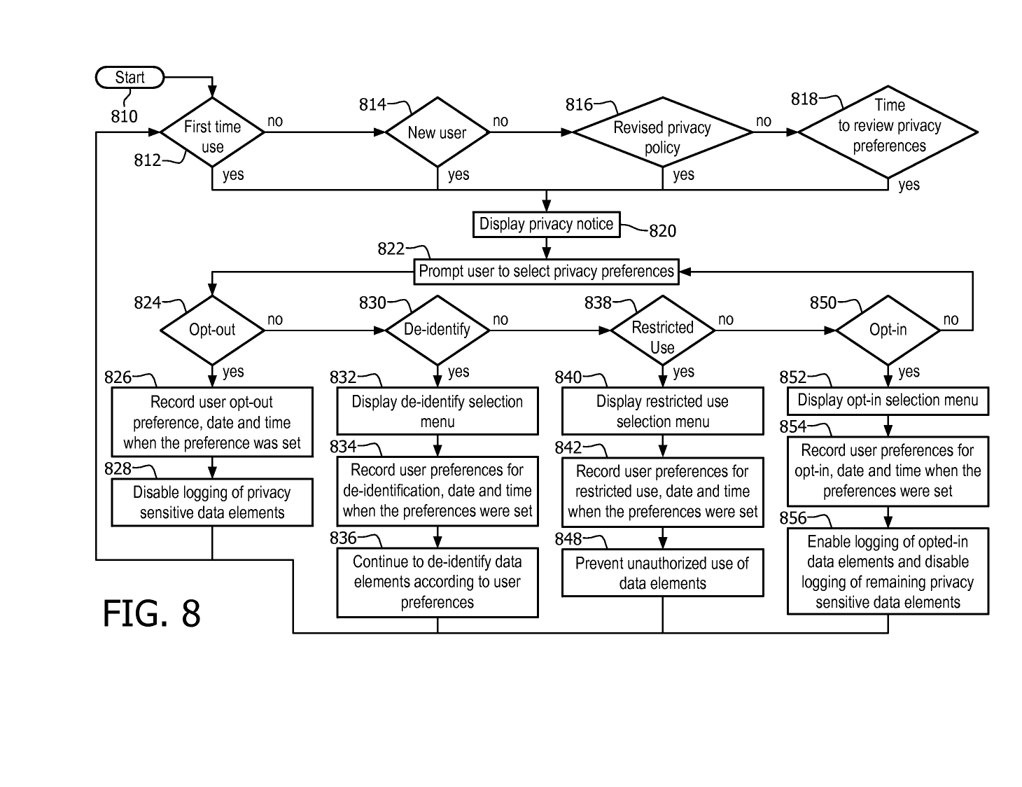

FIG. 8 illustrates a flow chart depicting an embodiment of the invention.

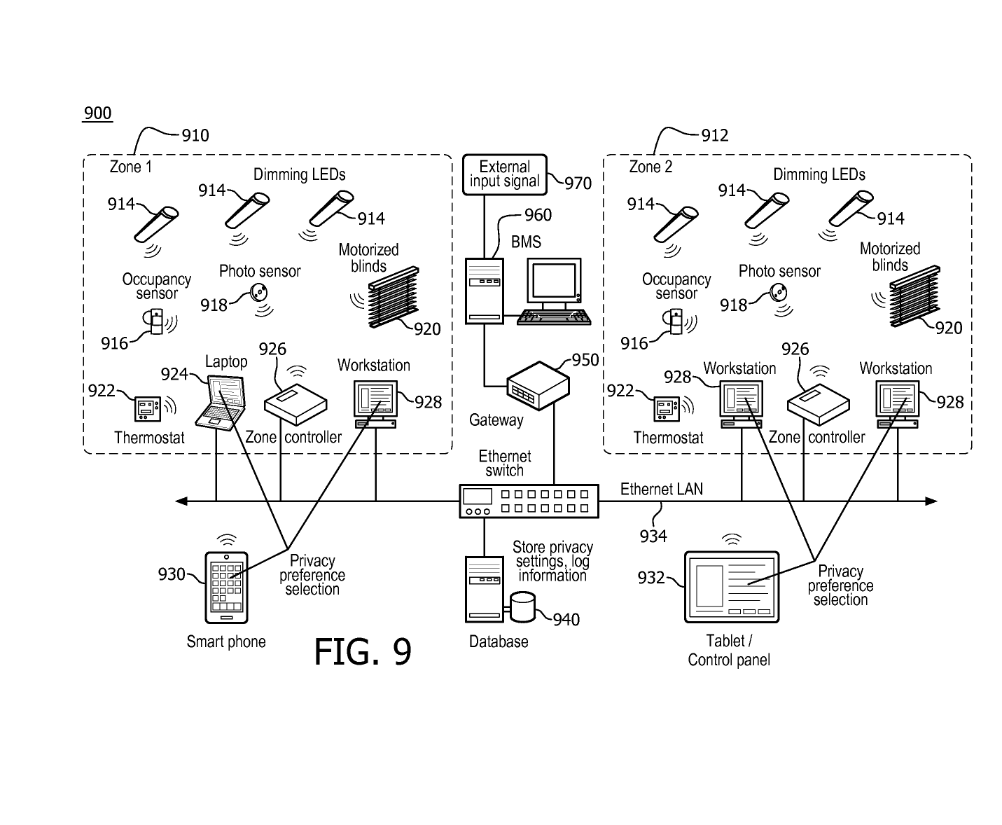

FIG. 9 illustrates exemplary system architecture and components for implementing the invention in an indoor or office environment.

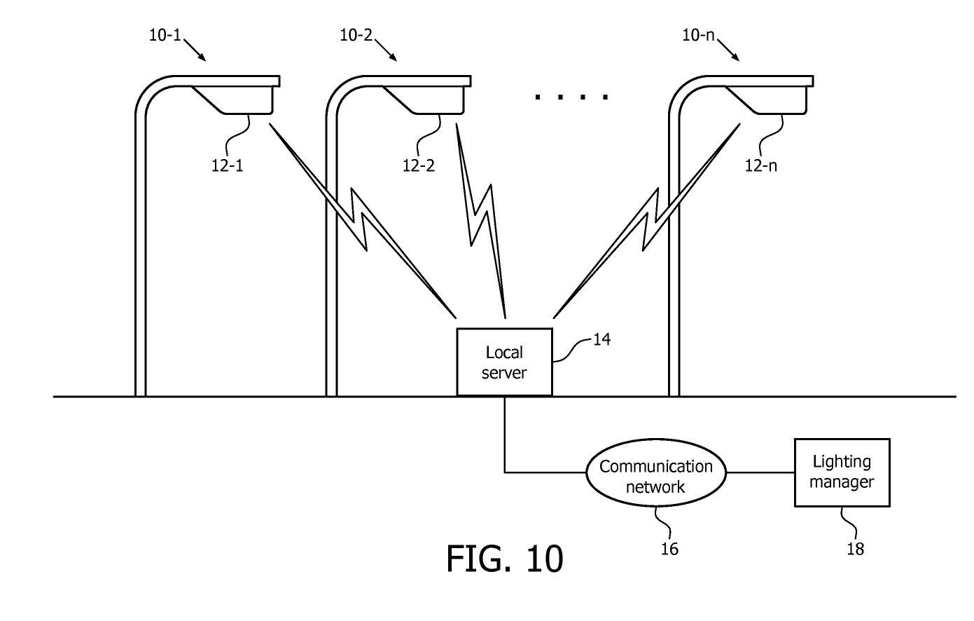

FIG. 10 illustrates exemplary system architecture and components for implementing the invention in an outdoor environment.

It is to be understood that these drawings are solely for purposes of illustrating the concepts of the invention and are not intended as a definition of the limits of the invention. It will be appreciated that the same reference numerals, possibly supplemented with reference characters, where appropriate, have been used throughout to identify corresponding parts.

Existing lighting control and shading systems typically operate independently, thereby leading to sub-optimal energy efficiency and causing inconvenience to users. Integrated control of artificial lights and motorized blinds provides for optimal use of natural light and artificial light while enhancing user comfort and productivity.

FIG. 1 illustrates a conventional ILDC system 100 wherein, each user's workstation or zone is associated with corresponding sensors, window blinds and fixtures to enable personalized integrated control. The system combines user preferences with sensor readings (occupancy and light level) to harvest natural light through integrated control of motorized blinds and electric light.

Each workstation or zone 110, 120 may incorporate motion sensors 130 and/or motorized blinds 140. In addition, light sensors 150 may be included, which monitor ambient light levels.

The motion sensors (occupancy sensors) 130 detect motion, as previously described, activate the lights 160. In addition, blinds 140 are capable of receiving commands to control the height of the blind and the angle of the blind with respect to a horizontal axis.

Each workstation or zone further includes control sensors 170 that monitor the corresponding workstation and provide control signals to at least the motorized blinds. The control sensors 170 are in communication, via a network 175, to a centralized control system 180 that maybe represented by server 185 and computer 190. The information obtained from the control units 170 may further be stored on permanent storage medium, depicted as MySQL Database 195 in the embodiment of FIG. 1.

FIG. 2 illustrates in further detail the integrated aspect of the ILDC system. In this case, occupational (occupancy) sensor 130 and glare control photo sensor 205 provide signals to integrated controller 210. The occupancy sensor 130, as discussed, provides a signal when motion is detected. The glare control photo sensor provides signals with regard to a level of glare or sunlight that is entering the workspace. Setpoint 220 provides a reference point against which the photo-sensor 230 output is compared. The deviation from setpoint 220 is deduced to derive the amount of artificial light from lighting system 160 that is needed, in combination with natural light, to satisfy the overall illumination needs of the user. That is artificial lights are regulated using occupancy sensor 130 and light sensors 150 and/or photosensor 230. The artificial lights are turned OFF when the space is vacant. When the space is occupied, blinds 140 are open to allow in daylight to an extent that the daylight does not cause discomfort (glare). The artificial light is dimmed so that the combination of artificial light and natural light meets the user's requirement.

The integrated controller 210 receives inputs from the setpoint 220, the occupancy sensor 130, photosensor 230 and the glare control sensor 205 to determine settings for the amount of artificial light and amount of natural light by adjusting the window covering (e.g., slat cutoff angle, window covering height, etc.). The photo sensor 230 monitors the level of light in the workspace and provides this information, as a feedback, to the integrated controller 210.

In determining the positions of the blinds, an open-loop blind height and slat angle control algorithm is implemented in ILDC system. Using a blind motor, the algorithm adapts blind height and slat angle periodically to avoid glare and enable daylight harvesting. A “cut-off angle” and “cut-off height” are calculated based factors such as latitude, longitude, orientation of window, date, local time and slat geometry. An example of the algorithm for computing the cut-off angle (defined as the angle beyond which no direct radiation is being transmitted through the slats) for blind slats may be found in “The Impact of Venetian Blind Geometry and Tilt Angle on View, Direct Light Transmission and Interior Illuminance,” A. Tzempelikos, Solar Energy, vol. 82, no. 12, pp. 1172-1191, December 2008, the contents of which are incorporated by reference, herein.

As noted above, the MySQL Database 195 of FIG. 1 permits storing of the configuration information for each zone—including device types and their locations, user credentials, user preferences and other system parameters. It is also used to log data containing real-time monitoring information of several system performance and operational metrics. MySQL is configured with system parameters at the time of commissioning the system. Examples of system configuration parameters include user credentials, IP addresses of zone controllers, device types and associations between devices and users.

In an NLCS system performance and operational data stored in MySQL 195 or similar database enables real-time display of system state to users, network administrators and facility managers. Furthermore, the stored data can be exploited for off-line analysis of usage patterns, energy savings, failures modes, light distributions and occupancy patterns.

In a modern lighting control system, sensors (e.g. motion) and actuators (e.g. lights) are linked to individual users to personalize system performance. Users can input their preferences via user interfaces which drive the system behavior. Sensor readings, user preferences and system parameters are stored in a database.

Sensor readings and user preferences in a NLCS have privacy and security implications. Building occupants have a reasonable expectation of privacy in their workplace. In the European Union there can be regulatory requirements on systems that process occupancy measurements that can be used to identify individuals. Such regulations include the requirement for Informed Consent before personally identifiable data is collected and the right of an individual to request information from the provider as to the processing of his/her personal data, including the right to “forget” the data.

Listed below are some examples of privacy and security implications of sensor measurements in a NLCS:
Occupancy sensor data from a private office can be used to deduce how much time a given office worker spends in his/her office—this has employment law and anti-discrimination implications.
Occupancy data can be used by an employer against the employee occupant (e.g. a guard was away from his/her desk for prolong time or during a specific event)
Spouse can subpoena occupancy data for divorce proceedings
FBI, Law-enforcement can subpoena occupancy data (like Cell-phone, EZ-pass toll records)
Occupancy data could be used against an organization (e.g. “Federal agency XYZ's employees spend less than 4 hrs on their desk wasting taxpayer's money”)
Real-time occupancy data can be exploited by a malicious entity to mount a coordinated attack (e.g. General xyz is in his office at this time, or the building is 90% occupied which makes it a high-value target)
Lighting systems can be personalized for individual users. A vision impaired user could require more light. Storing vision impairment information in the database in an identifiable way could violate user's privacy rights.
Light therapy is a recommended treatment for patients suffering for depression or Post Traumatic Stress Disorder. In a nursing home, hospital or mental health facility the light settings could be tailored for patients conditions. One could envisage a lighting control system for a psychiatric ward where light are set according to the prescription from a light therapist. In this case the settings in a given room could be linked to patient's health records.
Street location/movement information can be used by malicious users to stage a robbery. It could also be used by law-enforcement to surreptitiously track movement or determine past history of movement.

Further, in many installations, the NLCS systems are interfaced with third party systems. By way of example, Philips and Somfy have partnered to develop and market integrated lighting and motorized blind solutions. In this case, Philips system will provide room occupancy state information to Somfy system. Arguably, Philips could be held responsible if data is misused. Hence, it is crucial to develop methods to protect the security of networked lighting system and privacy of users.

Many protocols and methods (cookies, etc.) for online behavior tracking have been proposed or are in use for web-browsers and web-applications. Several privacy protection protocols and methods (P3P, “Do-not-track” protocols from Microsoft and Mozilla, etc.) have been proposed or have been deployed to allow users to control what is being tracked or recorded.
The P3P policy and protocol lists the following purposes for identifiable information:
<current/> Completion and Support of Activity For Which Data Was Provided:
<admin/> Web Site and System Administration:
<develop/> Research and Development:
<tailoring/> One-time Tailoring:
<pseudo-analysis/> Pseudonymous Analysis:
<pseudo-decision/> Pseudonymous Decision:
<individual-analysis/> Individual Analysis:
<individual-decision/> Individual Decision
<contact/> Contacting Visitors for Marketing of Services or Products:
<historical/> Historical Preservation:
<telemarketing/> Contacting Visitors for Marketing of Services or

Products Via Telephone:
<other-purpose> string </other-purpose> Other Uses:

Each type of purpose (with the exception of current) can have the following optional attribute:

Required

The attribute can take the following values:

always: The purpose is always required; users cannot opt-in or opt-out of this use of their data. This is the default when no required attribute is present.

opt-in: Data may be used for this purpose only when the user affirmatively requests this use

opt-out: Data may be used for this purpose unless the user requests that it not be used in this way.

In one aspect of the present invention, the personal privacy preferences of an individual could be an extension to an existing protocol (like P3P). In various embodiments of the invention, it is envisaged that the NLCS is a web-based application where the lighting system is operated and monitored as a web-application. End-users are permitted some level of access to such a system—e.g., to set their privacy preferences or to request that the lighting in their work space be made brighter (or dimmer). In further embodiments, a user's personal privacy settings (such as P3P settings) on his/her browser can be automatically uploaded when he/she logs in. Thus, by way of example, the user does not need to specifically request privacy setting changes as they can be determined from his/her browser (or Facebook or other) privacy settings.

The present invention provides a system and methods for protecting the privacy rights of the individual lighting system users while maintaining the overall functionality of the NLCS. That is, in the present invention the content and method of aggregating and storing data is permitted to be modified by individual users. In various embodiments of the invention, current (or operational) sensor data can and will continue to be used by the NLCS for Total Light Management purposes. Thereby the operational efficiency of the system is unaffected by these privacy choices. What is affected is the way in which stored data could be processed at a later time for problem resolution or improvements in the system performance or quality of service. That is, data is available for analysis but that data cannot be associated with an individual user if he had invoked privacy restrictions as described below.

As described below, the current invention contemplates a plurality of methods in permitting a user to invoke various privacy options. In one embodiment of the invention and as depicted in FIG. 3, an appropriate privacy policy notice 310 is displayed for user to accept 320 or decline 330. The user is prompted to make a selection before proceeding further.

In the event the user selects the Accept option, an additional GUI interface is displayed that presents various privacy options to the user. FIG. 4 illustrates an exemplary GUI menu which displays “Opt out” 410, “Opt De-identify” 420, “Opt Restricted Use” 430 and “Opt in” 440 selections.

It should be noted that in various embodiments of the invention these selection menus are displayed upon initial deployment of the system, upon a new occupant moving into a zone, periodically, or when the privacy policy is changed. Further, it is contemplated that the GUI screen exemplified by FIG. 3 is optional. That is, a user would be immediately presented with the GUI screen exemplified by FIG. 4, thereby requiring him to take an affirmative act in selecting or declining the privacy options available. These options will now be discussed in greater detail:

### “Opt Out” Selection 410:

This selection permits the user to opt-out from any identifiable data collected by the lighting system. That is, this selection results in disabling the logging of privacy sensitive data elements (such as occupancy, motion, light level, temperature, etc. . . . ). Consequently, the system will not store opt-out data elements.

### “Opt De-Identify” Selection 420:

The selection of this option results in a GUI menu exemplified by FIG. 5 being presented to the user. For each of the data elements selected, data will be stored such that it cannot be linked to an individual user thereby protecting the user's privacy. The system could provide the requested privacy yet preserve the utility of the data elements for statistical analysis. Various embodiments of the invention accomplish this feature by performing one or more of the following functions:
Remove primary keys from the database tables storing privacy sensitive information (e.g., do not store the ID of occupancy sensor in the occupancy log table);
In the case of outdoor lighting, do not store the Geo-location of the streetlamp or the ID of the streetlamp;
Store dummy values for userID, roomID, Occupancy sensor ID, etc. (e.g. use a randomized pseudonym for each user every day). This method allows individual user data to be used for statistical analysis without identifying the user(s) involved;
Use offsetted future values for datetime fields;
Combine data from multiple users so that data is anonymized; and,
Combine data from multiple sensors (e.g. ‘OR’ occupancy information) so that information cannot be traced to users

Additional embodiments of the invention provide the requested privacy at the cost of limiting the utility of data elements for statistical analysis (i.e., some information is lost). These embodiments of the invention accomplish this feature by performing one or more of the following functions:
Use time-based averaging (e.g., store only moving averages over many days); and,
Randomize the data with some stochastic noise. (i.e., spurious data)

### “Opt Restricted Use” Selection 430:

The selection of this option results in a GUI menu exemplified by FIG. 6 being presented to the user which lists the purposes for which collected data can be used (e.g., research and development, system performance analysis, energy audit, one-time tailoring, trend analysis, debugging, personalization, etc.)

“Opt in” Selection 440:

The selection of this option results in a GUI menu exemplified by FIG. 7 being presented to the user whereby he/she is offered a choice to opt-in various data elements available in the collection process. That is, the user is given control over the types of data collected by the system—the system will only store the selected opt-in data elements.

In additional embodiments of the invention, a user is required to log-in or otherwise authenticate himself before being able to select various options. Further, an individual would be limited in making these selections with respect to the specific room or office space that has been assigned to him. A central server or database would maintain passwords, work space assignments, and other data that is required to implement these features. In further embodiments this central location would also prevent users from making selections (inadvertently, or otherwise) that are contrary to corporate policy or governmental laws. Thus by way of example, a user may not elect recording of data related to “his” office space unless any and all workers who share that space also make that election.

FIG. 8 illustrates an exemplary embodiment of the present invention. At blocks 812-818, a determination is made whether this is a “First time use” of the system (Block 812), a “New user” (block 814), “Revised privacy policy” (block 816) and “Time to review privacy preferences” (block 818). If “yes” to either of these criteria, the method proceeds to block 820 where a “Display privacy notice” occurs.

Block 822 then prompts the user to select his privacy preferences. The system then determines which initial selection the user makes: “Opt-out” (block 824), “De-identify” (block 830), “Restricted Use” (block 838) or “Opt-in” (block 850). These selections correspond to items 410-440 of FIG. 4. In the event the selection was “Opt-out” (block 824), the system proceeds to block 826 where the opt-out preference(s) are recorded and time-stamped. At block 828 the system then performs the requested function by disabling logging of privacy sensitive data elements.

In the event the selection was “De-identify” (block 830), the system presents a selection menu to the user (block 832) and the subsequent selections are recorded and time-stamped (block 834). At block 836 the system then performs the requested function by de-identifying data elements according to the selected user preferences.

Similarly, in the event the selection was “Restricted Use” (block 838), the system presents a selection menu to the user (block 840) and the subsequent selections are recorded and time-stamped (block 842). At block 848 the system then performs the requested function by blocking unauthorized use of data elements.

In the event the selection was “Opt-in” (block 850), the system presents a selection menu to the user (block 852) and the subsequent selections are recorded and time-stamped (block 854). At block 856 the system then performs the requested function by enabling logging of opted-in data while disabling logging of remaining privacy sensitive data elements.

FIG. 9 illustrates a system 900 for implementing the principles of the invention as depicted in the exemplary processing shown herein. In this exemplary system embodiment 900, input data is received from a plurality of Zones 910, 912. This input data is obtained from one or more occupancy sensors 916, photo sensors 918 and thermostats 922. As similarly illustrated in FIGS. 1 and 2, an integrated controller 926 is located in each zone to utilize these input data items to control one or more lighting fixtures 914 and motorized blinds 920 located in each zone. Zone 1 depicts the presence of a single laptop computer 924 and a workstation 928 while Zone 2 depicts two workstations being present. The invention is not so limited as any number of such devices as can reasonably be expected in an office environment can be present in each zone. Further, as illustrated, additional input devices such as a smart phone 930 and tablet/control panel 932 are contemplated by the invention. Any and all of such devices are capable of being linked via a wireless or wired LAN and Gateway 950 to communicate with the Building Management System (BMS) computer 960. Accordingly, any of such devices have the capability of providing user selection of privacy settings as described above. Of course, the system requires proper configuration of the devices and appropriate user control security be implemented prior to such setting/changing of privacy settings.

As described above, once user privacy options are selected for one or more users, the system records data in accordance with those selections onto a database 940. This database is subsequently accessible by the Building Management System computer 960 to generate various analyses and reports to include those that are well-known in the NLCS field.

It should be noted that while depicted as an Ethernet LAN 934 in FIG. 9, alternative embodiments may include other well-known components of remote and wired communication networks, e.g., ISA, PCI, PCMCIA bus, one or more internal connections of a circuit, circuit card or other device, as well as portions and combinations of these and other communication media.

Laptop 924, workstation 928, smart phone 930 and Tablet/control panel 932 may be representative of a handheld calculator, special purpose or general purpose processing system, desktop computer, laptop computer, palm computer, or personal digital assistant (PDA) device, etc., as well as portions or combinations of these and other devices that can perform the operations illustrated.

Computer 960 may be a central processing unit (CPU) or dedicated hardware/software, such as a PAL, ASIC, FGPA, operable to execute computer instruction code or a combination of code and logical operations. In one embodiment, processor 960 may include code which, when executed by the processor, performs the operations illustrated herein. The code may be contained in the processor memory, may be read or downloaded from a memory medium such as a CD-ROM or floppy disk, may be provided by a manual input device, such as a keyboard or a keypad entry, or may be read from a magnetic or optical medium via one of the external inputs 970. It should be noted that in additional embodiments of the invention, these external inputs 970 would also include signals related to weather and/or signals from internet or third party systems (e.g., demand response signals).

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., serial, parallel, ISA bus, microchannel bus, PCI bus, PCMCIA bus, USB, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

As would be understood, the operations illustrated may be performed sequentially or in parallel using different processors to determine specific values. Processing system 710 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, network 934 may also comprise internal networks or one or more internal connections of a circuit, circuit card or other device, as well as portions and combinations of these and other communication media or an external network, e.g., the Internet and Intranet.

FIG. 10 is a block diagram of an outdoor lighting system using streetlights that contain various sensors according to a further embodiment of the present invention. Referring to FIG. 10, the system includes lighting units 12-1 to 12-n installed in a plurality of streetlights 10-1 to 10-n. According to the present invention, each of the lighting units 12-1 to 12-n includes one or more lighting elements and one or more sensors for monitoring its installation area. In an alternative embodiment, the sensors need not be integrated into the lighting unit, but rather be another wireless or wired device in the TLMS that can communicate with one or more lighting units and/or with a lighting manager 18. In further embodiments, the lighting units do not always have to directly communicate with a local server 14—that is, they may also form a mesh network, where lighting units use other nearby lighting units to communicate with the local server 14.

As illustrated in FIG. 10, the communication network comprises communication with the lighting manager 18 through a local server 14. While FIG. 10 illustrates wireless communication with lighting units 12, it should be noted that the invention is not limited to this embodiment as other types of communication are contemplated by the invention, to include the various communication means described above with respect to FIG. 9. As data is collected from these sensors, it is transmitted to the lighting manager 18 where it is time-stamped and stored with appropriate indexing as to its location of origin.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated. For example, any numerical values presented herein are considered only exemplary and are presented to provide examples of the subject matter claimed as the invention. Hence, the invention, as recited in the appended claims, is not limited by the numerical examples provided herein.

1. A method for protecting the privacy of an individual in a space in which data is capable of being collected and stored by a central lighting control system, the method comprising, wherein the data is used for operational aspects of the lighting control system and/or for analysis of the lighting control system:
displaying to the individual a menu by which the individual can select various privacy settings pertaining to the analysis of the data wherein the privacy settings include allowing the lighting control system to associate the collected and stored data to the individual or not;
recording one or more selections made by the individual; and,
collecting data in accordance with the recorded selections.

2. The method of claim 1 wherein the lighting control system is a Hybrid Integrated Lighting and Daylight Control system and the data relates to the individual's work space.

3. The method of claim 1 wherein the collecting step comprises obtaining information from devices, said devices consisting of a camera, a light, a sensor, a dimming ballast, a user interface, motorized blinds, and combinations thereof.

4. The method of claim 3 wherein said sensors are selected from the group consisting of an occupancy sensor, a motion detector, a light sensor, a thermal sensor, a temperature sensor, a humidity sensor, and combinations thereof.

5. The method of claim 1 further comprising:
reporting of any collected data in accordance with the recorded selections.

6. The method of claim 2 wherein the privacy settings comprise an “Opt Out” option, whereby the individual can specify one or more data element categories for which data associated with his work space is not to be collected.

7. The method of claim 2 wherein the privacy settings comprise an “Opt De-Identify” option, whereby the individual can specify one or more data element categories for which data associated with his work space is permitted to be collected but said collected data is incapable of being linked to his work space.

8. The method of claim 2 wherein the privacy settings comprise an “Opt Restricted Use” option, whereby the individual can limit what purposes the collected data associated with his work space is permitted to be used.

9. The method of claim 2 wherein the privacy settings comprise an “Opt In” option, whereby the individual can specify one or more data element categories for which data associated with his work space is permitted to be collected.

10. A method for protecting the privacy of an individual in an area in which data is capable of being collected and stored by a Networked Lighting Control System (NLCS) in accordance with the individual's preferences, the method comprising:
automatically uploading the individual's privacy settings from his browser settings when the individual logs in to the NLCS system, wherein the privacy settings include allowing the lighting control system to associate the collected and stored data to the individual or not;
recording said privacy settings; and,
collecting data in accordance with the privacy settings.

11. A control system that provides protection of the privacy of an individual in an area in which data is capable of being collected and stored by the central lighting control system, the system comprising:
a plurality of devices for which data related to the area can be obtained;
a network for communicating the data to a central computer;
a means for providing the individual a menu by which he can select various privacy settings related to collecting the data, and transmitting said settings to the computer, wherein the privacy settings include allowing the lighting control system to associate the collected and stored data to the individual or not; and,
a database associated with the computer wherein data is collected in accordance with said privacy selections.

12. The system of claim 11 wherein the devices consist of a camera, a light, a sensor, a dimming ballast, a user interface, motorized blinds, and combinations thereof.

13. The system of claim 12 wherein the sensors are selected from the group consisting of an occupancy sensor, a motion detector, a light sensor, a thermal sensor, a temperature sensor, a humidity sensor, and combinations thereof.

14. The system of claim 11 wherein the central computer generates collected data reports in accordance with said selections.

15. The system of claim 11 wherein the means for providing is selected from the group consisting of a special purpose or general purpose processing system, a desktop computer, a laptop computer, a palm computer, a personal digital assistant (PDA), a smart phone, and combinations thereof.

16. A computer-readable, non-transitory medium having stored therein instructions for causing at least one processing unit to execute a method according to claim 1.

17. The method of claim 1 wherein the central lighting control system relates to an outdoor lighting facility.

18. The method of claim 17 wherein the data relates to one or more outdoor areas in proximity to the individual's home.

19. The method of claim 17 wherein the data relates to one or more outdoor areas in proximity to the individual's workplace.

20. The method of claim 11 wherein one or more of the plurality of devices are located within outside lighting units.
